(19) United States
(12) Patent Application Publication
(10) Pub. No.: US 2025/0094840 A1
(43) Pub. Date: Mar. 20, 2025

(54) INFERENCE MODEL SELECTION METHOD CONSIDERING TASK REQUEST RATE

(71) Applicant: KOREA UNIVERSITY RESEARCH AND BUSINESS FOUNDATION, Seoul (KR)

(72) Inventors: Sangheon PACK, Seoul (KR); Haneul KO, Sejong-Si (KR); Hyeonjae JEONG, Seoul (KR)

(21) Appl. No.: 18/443,445

(22) Filed: Feb. 16, 2024

(30) Foreign Application Priority Data
Sep. 14, 2023 (KR) 10-2023-0122651

(51) Int. Cl. G06N 5/04

(52) U.S. Cl. CPC G06N 5/04

(57) ABSTRACT

Disclosed is an inference model selection method and apparatus considering a task request rate. The inference model selection method is performed by a computing device including a processor and includes monitoring computing resources of the computing device; receiving a task; selecting an inference model to perform inference for the received task; inputting the task into a queue of the selected inference model; and performing an inference operation.

### CROSS-REFERENCE TO RELATED APPLICATION(S)

This application claims the benefit under 35 USC § 119 (a) of Korean Patent Application No. 10-2023-0122651 filed on Sep. 14, 2023 in the Korean Intellectual Property Office, the entire disclosure of which is incorporated herein by reference for all purposes.

### BACKGROUND

### 1. Field

At least one example embodiment relates to a method of selecting a Single-task Learning (STL) model or a Multi-task Learning (MTL) model according to a task request rate.

### 2. Description of Related Art

Deep learning (DL) refers to technology that performs learning based on data and then derives an analysis result through an inference process. In general, deep learning refers to using a neural network that performs a single task, that is, a Single-task Learning (STL) model and learns data through a method of computing weights of neurons that constitute a network. Therefore, since the existing STL focused on a single task, there were limitations in terms of computing resources in an environment that had to process multiple tasks. For example, an analysis result, such as mobile traffic classification, mobile traffic prediction, mobile mobility prediction, and resource usage prediction of radio access network (RAN) within a short period of time to analyze mobile traffic characteristics, is required and thus, if the STL model is used, computing resources need to be allocated to each task for task performance, which leads to consuming a large amount of computing resources. If a plurality of task requests is present within a limited time, a required delay time of a task may not be satisfied due to high computing load on a network device capable of performing inference (e.g., mobile, edge equipment, core equipment).

A Multi-task Learning (MTL) model was developed to process multiple tasks with a single model. The MTL model may simultaneously learn and infer a plurality of tasks and may extract an independent feature for each task. Initially, the MTL model was designed to minimize interdependency between tasks and to improve model accuracy through data sharing and comparison between tasks. However, recently, research using an advantage that the MTL model may reduce a learning time and a computing resource usage is being actively conducted in various fields. As such, the MTL model has an advantage of acquiring efficient results in terms of computing resources over the STL model, but there is an issue in that a different required delay time of each task may not be satisfied since the respective tasks are simultaneously computed. Therefore, to utilize advantages of the MTL model, it is important to consider characteristics of each task, such as a task request rate and a task delay time of a task and selectively use the STL model and the MTL model accordingly.

The existing deep learning-related techniques are based on a single task. Since this does not consider a task request rate and computing resources used to process a task, it is difficult to acquire a desired inference delay time due to lack of resources in an environment with a high task request rate. Therefore, herein, proposed is a method of selecting an appropriate inference model to satisfy a task delay time of a task while considering a task request rate and computing resources.

To maintain accuracy, the MTL model typically consumes the same or higher computing resources (floating-point operations per second (FLOPS)) than the STL model. Therefore, herein, it is assumed that the MTL model consumes the same computing resources as the STL model. Examples of a task type may include mobile traffic classification, mobile traffic prediction, mobile mobility prediction, and resource usage prediction of RAN, and each network task has a required delay time within a wide range of seconds to minutes. When a network device capable of performing inference (e.g., mobile, edge equipment, core equipment) receives a task request, the network device determines whether to immediately perform inference using the STL model or to wait for a task to be inferred with the MTL model.

In the case of selecting STL for all tasks in a case in which a task request rate is low, a task delay time of each task may be satisfied. However, in the case of selecting STL for all tasks in a case in which a task request rate is high, computing resource efficiency may be degraded due to limitations in computing resources and a task delay time of each task may not be satisfied. Likewise, in the case of selecting MTL for all tasks in a case in which a task request rate is high, computing resource efficiency may be high, but a required delay time of each task may not be satisfied. To this end, herein, proposed is a method of adaptively selecting an inference model according to a change in a task request rate. That is, by adaptively selecting the STL model and the MTL model according to a task request rate, a required delay time of a task may be satisfied while efficiently utilizing computing resources.

To this end, herein, proposed is a method of selecting an inference model to efficiently utilize computing resources in consideration of task characteristics (e.g., task request rate and required delay time of each task). The proposed method formulates a problem with a Markov Decision Process (MDP) to determine an optimal inference model according to task characteristics and finds an optimal policy using Q-learning.

### SUMMARY

A technical subject of at least one example embodiment is to provide a method of selecting an inference model by considering a task request rate.

According to an aspect of at least one example embodiment, there is provided an inference model selection method and apparatus considering a task request rate. The inference model selection method is performed by a computing device including a processor and includes monitoring computing resources of the computing device; receiving a task; selecting an inference model to perform inference for the received task; inputting the task into a queue of the selected inference model; and performing an inference operation.

According to some example embodiments, an inference model selection method considering a task request rate may select an inference model suitable for each task by considering the task request rate and a required delay time of each task.

The aforementioned features and effects of the disclosure will be apparent from the following detailed description related to the accompanying drawings and accordingly those skilled in the art to which the disclosure pertains may easily implement the technical spirit of the disclosure.

This research was supported by the MSIT (Ministry of Science and ICT), Korea, under the ITRC (Information Technology Research Center) support program (IITP-2024-RS-2022-00156353) supervised by the IITP (Institute for Information & Communications Technology Planning & Evaluation). And, this work was supported by Institute of Information & Communications Technology Planning & Evaluation (IITP) grant funded by the Korea government (MSIT) (No. 2022-0-01015, Development of Candidate Element Technology for Intelligent 6G Mobile Core Network).

### BRIEF DESCRIPTION OF THE DRAWINGS

These and/or other aspects, features, and advantages of the disclosure will become apparent and more readily appreciated from the following description of example embodiments, taken in conjunction with the accompanying drawings of which:

FIG. 1 illustrates an inference model selection apparatus according to an example embodiment;

FIG. 2 is a graph showing average reward change of a proposed method and a comparative method when a task request rate is 1;

FIG. 3 is a graph showing average reward change of a proposed method and a comparative method when a task request rate is 2; and

FIG. 4 is a flowchart illustrating an inference model selection method performed by the inference model selection apparatus of FIG. 1.

### DETAILED DESCRIPTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Example embodiments of the present invention are described with reference to the accompanying drawings. However, the scope of the claims is not limited to or restricted by the example embodiments. Like reference numerals proposed in the respective drawings refer to like elements.

Hereinafter, example embodiments will be described with reference to the accompanying drawings. However, the scope of the patent application is not limited to or restricted by such example embodiments. Like reference numerals used herein refer to like elements throughout.

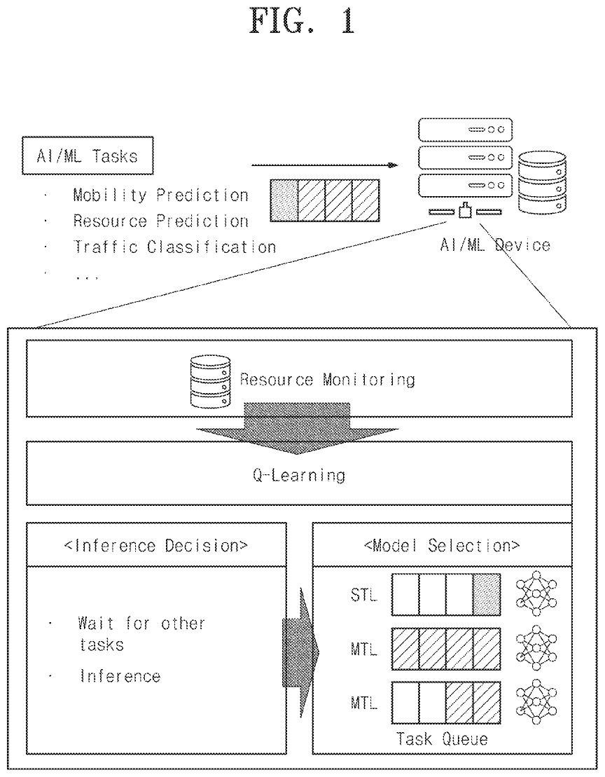

FIG. 1 illustrates an inference model selection apparatus according to an example embodiment. The inference model selection apparatus may be implemented as a computing device including a processor and/or a memory. Therefore, at least some of operations included in an inference model selection method according to an example embodiment may be understood as an operation of the processor included in the computing device. The computing device may include, for example, a personal computer (PC), a server, a laptop computer, a tablet PC, and a smart phone.

Depending on example embodiments, the inference model selection apparatus includes an inference equipment (artificial intelligence/machine learning (AI/ML) device) capable of performing inference and AI/ML tasks requested to a corresponding equipment. The inference equipment is configured to verify a status of computing resources every time t and to allow remaining computing resources to be considered when selecting an inference model upon a task request. The inference equipment maintains a plurality of Single-task Learning (STL) models and Multi-task Learning (MTL) models up to date for task inference and maintains a task queue for each model. When a task is requested to the inference equipment with information on a required delay time, the inference equipment may initially verify whether the task is inferable with the STL and MTL models and may input the task to a Q-learning module. According to an interference model decision made by the Q-learning module, the task is recorded in an STL model queue or an MTL model queue. For a task input to the STL model queue, inference immediately starts. For a task input to the MTL queue, inference is performed if the queue is full or if there is any task close to the required delay time among tasks waiting in the queue.

The aforementioned information (available resource information of the inference equipment and required delay time information of a task) is input as input of the Q-learning module. A corresponding function performs an operation procedure described below and then selects an inference model of a task as output. An inference model selection decision in the inference equipment defines that a total of N tasks are present and each task has a different required delay time and a task elapsed time (waiting time in a queue and a computing time (which may indicate an inference time)) to formulate a system model. Inference model section in the inference equipment is simultaneously performed for all tasks present in the inference equipment every time τ. The purpose of selection is to minimize resource usage while satisfying a required delay time of each task.
Operation procedure
Operation process 1: MDP modeling
Definition of state space S
The state space S is defined as the following equation:

$$S = C \times {\prod }_{n}^{N} {K}_{n} \times {T}_{n}$$

In the above equation, C={0,1,2, . . . , Cₘₐₓ} represents computing resources and n={0,1,2, . . . ,N} represents the number of tasks. Each task may have a different required delay time. K={0,1,2,3} represents a task state. In detail, Kₙ=0 represents a state in which a task request is absent, Kₙ=1 represents a state in which the task request has arrived and is waiting, Kₙ=2 represents a state in which task inference is ongoing, and Kₙ=3 represents a state in which the task inference is completed. T={0,1,2, . . . , Tₘₐₓ} represents an elapsed time of a task.

Definition of action space A.

The action space A is defined as the following equation:

$$A = {\prod }_{n}^{N} {A}_{n}$$

In the above equation, Aₙ={0,1,2,3,4} and Aₙ=0 represents waiting without performing inference for task n. Aₙ=1 represents inference with an STL model. Aₙ=2, Aₙ=3, and Aₙ=4 represent inference with an MTL model using 2 tasks, 3 tasks, and 4 tasks as output, respectively.

Definition of reward function R

The reward function R is defined as the following equation:

$$R = \frac{t}{r}$$

In the above equation, r={0,1, . . . ,rₘₐₓ}, which represents the number of inferences. t={0,1,2, . . . , tₘₐₓ}, which represents the number of output tasks. If a required delay time of a task is satisfied, R is acquired and otherwise, 0 is acquired:

Operation process 2: optimization process

A final goal of the MDP model defined in operation process 1 is to find an optimal policy that takes a specific action in a specific state. In the above environment, it is difficult to exactly know which action will result in a greatest reward in all states, that is, all cases of computing resources, task states, and task delay time since there are so many cases. Therefore, the present invention finds the optimal policy using Q-learning capable of searching for the optimal policy without full explanation of the environment. The optimal policy may be acquired by substituting the MDP model in a Q-function as follows. Q values for all states and actions are calculated according to the following equation:

$$Q ( {S}_{τ} , {A}_{τ} ) = ( 1 - α ) Q ( {S}_{τ} , {A}_{τ} ) + α ( {R}_{τ + 1} + γ \times max Q ( {S}_{τ + 1} , {A}_{τ + 1} ) )$$

In the above equation, 0≤γ≤1 denotes a discount factor and 0≤α≤1 denotes a learning rate. Each of γ and a may have a preset value.

The Q-function selects action A every time τ, receives reward R, transitions to new state S_{τ+1}, and updates a Q value. The Q-function that found the optimal policy may be represented as follows:

Q,(S,A)=max_{π}[Q_{π}(S,A)]

In the above equation, π denotes a policy and allows an action to be taken to be selected in each state. To acquire the optimal policy, the present invention transforms the MDP model to Q-Learning. The optimal policy may be derived by solving the aforementioned problem. The result derived from the above equation is selection of an optimal inference model that minimizes resource usage and satisfies a required task delay time.

The environment considered herein assumes all the network environments in which a task request rate is dynamic and computing resources are limited. This may be applied to overall network devices, for example, a mobile and a server having a dynamic task generation rate and capable of performing inference, such as mobile mobility, radio access network (RAN) resource usage prediction, network slice load prediction, and content caching. Also, this is advantageous in terms of infrastructure management and cost by showing great efficiency and facilitating resource management in an environment with a high task request rate.

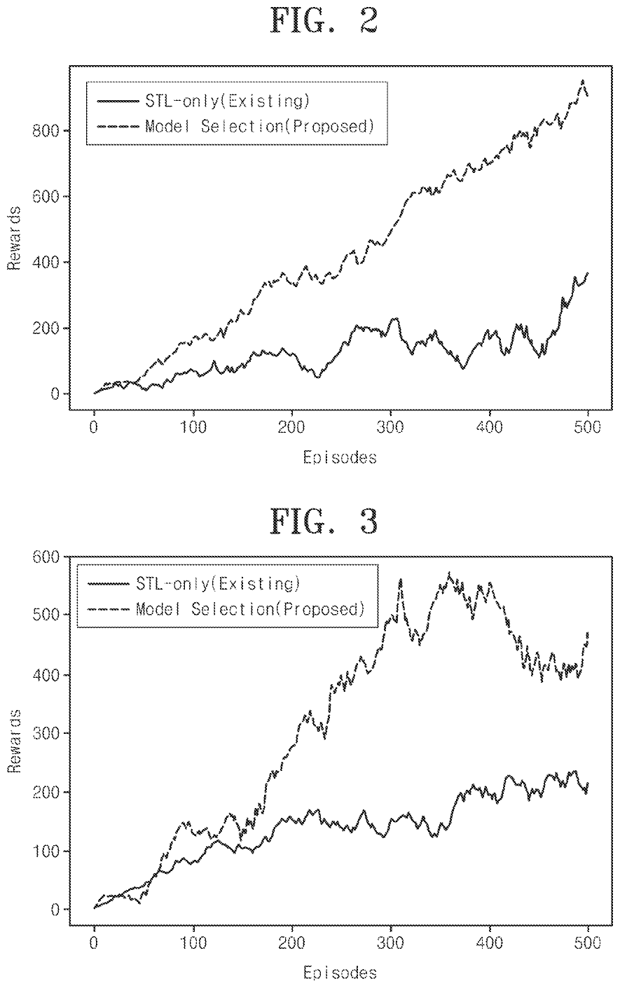

FIGS. 2 and 3 are graphs showing average reward change over time when a task request rate per unit time is 1 and 2, respectively. This simulation allows the proposed technique to be capable of inferring tasks from 2 tasks to a maximum of 4 tasks with an MTL model. This simulation compares the proposed technique (dotted line) with an existing technique (solid line) that uses only an STL model without a process of selecting an inference model for a reward change according to a task request rate. As shown in FIGS. 2 and 3, it can be seen from two experimental results that the proposed technique has a higher reward than that of the existing technique and, when the task request rate is high (FIG. 3), both techniques have low rewards due to limited computing resources. This may be because the proposed technique applies a policy of inferring as many tasks as possible with the same computing resources without exceeding a required delay time of each task.

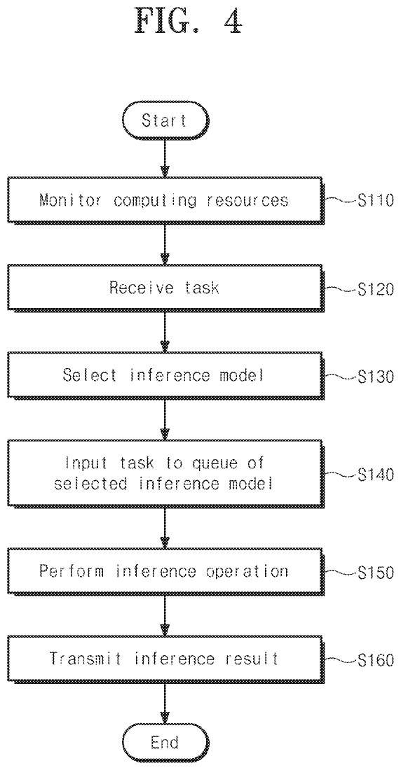

FIG. 4 is a flowchart illustrating an inference model selection method performed by the inference model selection apparatus of FIG. 1. In describing the inference model selection method, which may also be referred to as an inference method, detailed description of contents that overlap the aforementioned description is omitted.

In operation S110, monitoring of computing resources is performed. A monitoring operation may be periodically performed based on a predetermined period (e.g., t seconds). Computing resources, such as computing power, refer to computing resources available for an inference operation and may be derived as a quantified expression according to a predetermined rule. Therefore, a model selection operation may be performed based on computing resources periodically updated. Additionally, it is assumed that input data for inference of each of a plurality of inference models is periodically or aperiodically monitored or received from an external device and secured.

In operation S120, a task is received. The task may be received from the external device through a wired/wireless communication network. Here, the task may be received with information of a required delay time of the corresponding task. Depending on example embodiments, the task may further include data used as input of the inference model. Also, the task may include mobile traffic classification, mobile traffic prediction, mobile mobility prediction, resource usage prediction of RAN, network slice load prediction, and content caching, as a request for an inference operation for an arbitrary inference model. However, the scope of the present invention is not limited to types of tasks and various tasks may be present in addition to the aforementioned tasks. A required delay time of each task may be the same or different.

In operation S130, an inference model to perform the received task is selected. Depending on example embodiments, an inference model selection operation may be performed at predetermined periods, for example, every time τ. In this case, the inference model selection represents selection of an appropriate inference model for tasks received over the predetermined period. Aₙ inference model to be assigned to each task may be derived by solving a Q-function derived as a result of transforming an MDP model to Q-Learning.

When selection of the inference model is completed, each task is input to a queue of the selected inference model in operation S140. Here, a plurality of STL models and/or MTL models may be present and, in this case, a corresponding queue is provided in each model. Therefore, a plurality of inference models (at least one STL model and at least one MTL model) may be prestored in the computing device that performs the inference model selection method.

In operation S150, an inference operation is performed. A different inference operation may be performed according to a corresponding inference model. For example, in the case of the STL model, the inference operation may be immediately performed for a task input to a queue without a waiting time and an inference result may be derived after a predetermined inference time (which may also be referred to as a computing time). In the case of the MTL model, if a corresponding queue is full of tasks, the inference operation may be performed. As another example, in the case of the MTL model, if there is any task close to a required delay time among tasks waiting in the queue, the inference operation may be performed although the queue is not full of tasks. For example, when a sum of a time elapsed from a point in time at which a corresponding task is received and a computing time of the inference model is equal to a required delay time of the corresponding task (or a value acquired by subtracting a predetermined period of time from a required delay time), or when a sum of an amount of waiting time of a task in the queue and a computing time of an inference model is equal to a required delay time of the corresponding task (or a value acquired by subtracting a predetermined period of time from a required delay time), an inference operation of the corresponding MTL model may be performed.

In operation S160, an inference result may be transmitted to an external device that transmitted the task. Since an inference model is selected by considering a required delay time of each task and an inference result is derived before the required delay time elapses, the inference result may be transmitted to the corresponding external device while satisfying the required delay time.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. Aₙ inference model selection method performed by a computing device comprising a processor, the interference model selection method comprising:
monitoring computing resources of the computing device;
receiving a task;
selecting an inference model to perform inference for the received task;
inputting the task into a queue of the selected inference model; and
performing an inference operation.

2. The inference model selection method of claim 1, wherein the monitoring is periodically performed at predetermined periods.

3. The inference model selection method of claim 2, wherein the selecting of the inference model comprises selecting an appropriate inference model for tasks received over the predetermined period, and
the inference model includes at least one Single-task Learning (STL) model and at least one Multi-task Learning (MTL) model.

4. The inference model selection method of claim 3, wherein the selecting of the inference model comprises solving a Q-function derived as a result of transforming a Markov Decision Process (MDP) model to Q-Learning, and
the Q-function is represented as Q,(S,A)=max_{π}[Q_{π}(S,A)],
where S denotes a state space, A denotes an action space, and π denotes a policy.

5. The inference model selection method of claim 4, wherein the performing of the inference operation comprises performing the inference operation by inputting a task input to a queue to the STL model without a waiting time if the STL model is selected.

6. The inference model selection method of claim 5, wherein the performing of the inference operation comprises performing the inference operation by, when the queue is full of tasks, inputting the task input to the queue to the MTL model if the MTL model is selected.

7. The inference model selection method of claim 5, wherein the performing of the inference operation comprises performing the inference operation by, when a sum of a time elapsed from a point in time at which at least one task stored in the queue is received and a computing time required for inference is equal to a value acquired by subtracting a predetermined period of time from a required delay time, inputting all the tasks stored in the queue to the MTL model, if the MTL model is selected.

8. The inference model selection method of claim 5, wherein the performing of the inference operation comprises performing the inference operation by, when a sum of a waiting time of a task in the queue and a computing time required for inference is equal to a value acquired by subtracting a predetermined period of time from a required delay time, inputting all the tasks stored in the queue to the MTL model, if the MTL model is selected.

9. The inference model selection method of claim 8, further comprising:
transmitting an inference result.
